(19) United States
(12) Patent Application Publication
(10) Pub. No.: US 2009/0196773 A1
(43) Pub. Date: Aug. 6, 2009

(54) FAN AND MOTOR

(75) Inventors: Chen-Mo JIANG, Taoyuan Hsien (TW); Hung-Chi CHEN, Taoyuan Hsien (TW); Te-Tsai CHUANG, Taoyuan Hsien (TW); Kuo-Cheng LIN, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC, Taoyuan Hsien (TW)

(21) Appl. No.: 12/210,153

(22) Filed: Sep. 12, 2008

(30) Foreign Application Priority Data
Feb. 5, 2008 (TW) 097104473

(51) Int. Cl. F04B 17/03; H02K 5/124; F04D 29/046

(52) U.S. Cl. 417/423.14; 310/88; 417/423.12

(57) ABSTRACT

A foreign-body-proof or water-proof fan includes an impeller and a motor. The motor includes a rotor, a stator, a housing, at least one bearing and a spacer. The rotor has a shaft. The stator is disposed corresponding to the rotor. The housing supports for the stator and the rotor and has an axial hole, and the shaft passes through the axial hole. One end of the shaft protrudes out of the housing and is connected to the impeller. The bearing for supporting the shaft is disposed in the axial hole and securely disposed in the axial hole. The spacer loops the shaft and urges against the bearing.

### CROSS REFERENCE TO RELATED APPLICATIONS

This Non-provisional application claims priority under 35 U.S.C. §119(a) on Patent Application No(s). 097104473, filed in Taiwan, Republic of China oil Feb. 5, 2008, the entire contents of which are hereby incorporated by reference.

### BACKGROUND OF THE INVENTION

1. Field of Invention

The present invention relates to a fan and a motor, and in particular to foreign-body-proof or water-proof fan and motor.

2. Related Art

The motor converts the electric energy into the mechanical energy and is widely used in mechanical structures, such as fans.

Referring to FIG. 1, a conventional fan 1 is a motor combines with an impeller 2. The shaft penetrates through the bushing and the bearing, extending out of the motor base 10, and is coupled to the impeller 2. Due to gaps G are formed between the motor base 10 and the impeller 2 and between the stator 12 and the motor base 10, the foreign bodies, water or dust in the external environment may enter the bearing or the stator 12 through the gaps G. Thus, the motor may become abnormal or may be damaged, so that the reliability of the motor is decreased and the lifetime of the motor is shortened.

### SUMMARY OF THE INVENTION

In view of the foregoing, the present invention is to provide a foreign-body-proof or water-proof fan and a motor thereof.

To achieve the above, the present invention discloses a motor includes a rotor, a stator, a housing, at least one bearing and a spacer. The rotor has a shaft, and the stator is disposed corresponding to the rotor. The housing supports for the stator and the rotor and has an axial hole. The bearing is disposed in the axial hole to support the shaft. The spacer is securely disposed in the axial hole, loops the shaft, and urges against the bearing.

The present invention also discloses a fan includes an impeller and a motor. The motor includes a rotor, a stator, a housing, at least one bearing and a spacer. The rotor has a shaft, and the stator is disposed corresponding to the rotor. The housing supports for the stator and the rotor and has an axial hole. The shaft passes through the axial hole, and one end of the shaft protrudes out of the housing and is connected to the impeller. The bearing is disposed in the axial hole for supporting the shaft. The spacer is securely disposed in the axial hole, loops shaft, and urges against the bearing.

The spacer is formed by way of powder metallurgy, aluminum casting or plastic injection molding. The spacer has at least one flange, which is mounted around a periphery of the spacer and shields the axial hole. Alternatively, the spacer has a plurality of flanges, which are disposed separately and in parallel for shielding the axial hole. The flange(s) and the spacer can be formed by way of lathing, molding or injection molding.

The housing combines a first casing with a second casing, which are assembled with each other by way of screwing, locking or engaging. An airtight space for accommodating the stator and the rotor is formed between the first casing and the second casing. The fan further includes a driving device, which is also disposed in the airtight space. The material of the first and second casings is a plastic or metallic material.

The impeller includes a hub and a plurality of blades mounted around a periphery of the hub. The shaft is connected to the impeller via a bracket, and the spacer is disposed between the bearing and the bracket.

Preferably, the housing includes a rib disposed on a periphery of the axial hole. More preferably, the housing includes a sleeve having a rib disposed on the periphery of the axial hole.

The rib has an axial extension and a radial extension extending toward a center of the shaft. A central portion of the spacer is tightly secured to the axial hole defined by the radial extension. A lateral portion of the spacer is securely couple to the axial extension of the rib. The motor is an inner rotor motor, an outer rotor motor or a vehicle motor.

As mentioned hereinabove, the foreign-body-proof and water-proof fan and motor according to the present invention have the spacer coupled to the shaft to shield the axial hole of the housing. More specifically, the structure, such as the flange, of the spacer is provided to shield the axial hole, and prevent the external moisture or water from entering the axial hole so as to protect the member in the axial hole, such as the bearing. Compared with the prior art, the present invention can effectively prevent the water and external foreign bodies from entering the motor. Thus, the lifetime of the bearing or the stator can be lengthened.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram of a conventional fan;

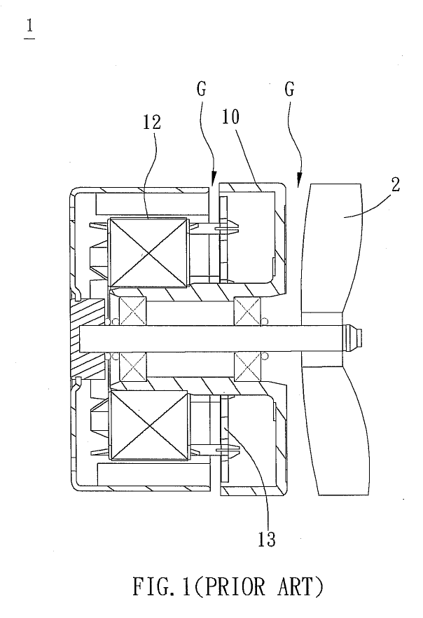

FIG. 2 is a schematic diagram showing a cross-sectional view of a fan according to a first embodiment of the present invention;

FIG. 3 is a schematic diagram showing a cross-sectional view of a fan according to a second embodiment of the present invention;

FIG. 4 is a schematic diagram showing a cross-sectional view of a fan according to a third embodiment of the present invention; and

FIG. 5 is a schematic diagram showing a cross-sectional view of a fan according to a fourth embodiment of the present invention.

### DETAILED DESCRIPTION OF THE INVENTION

The present invention will be apparent from the following detailed description, which proceeds with reference to the accompanying drawings, wherein the same references relate to the same elements.

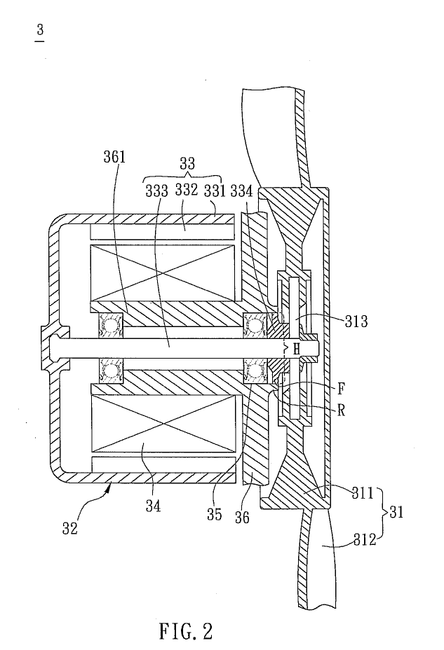

Referring to FIG. 2, a fan 3 according to a first embodiment of the present invention includes an impeller 31 and a motor 32. The impeller 31 includes a hub 311 and a plurality of blades 312, which is disposed a periphery of the hub 311. The motor 32 includes a rotor 33, a stator 34, at least one bearing 35 and a housing 36. In this embodiment, the motor 32 is an outer rotor motor and is applied as a vehicle motor.

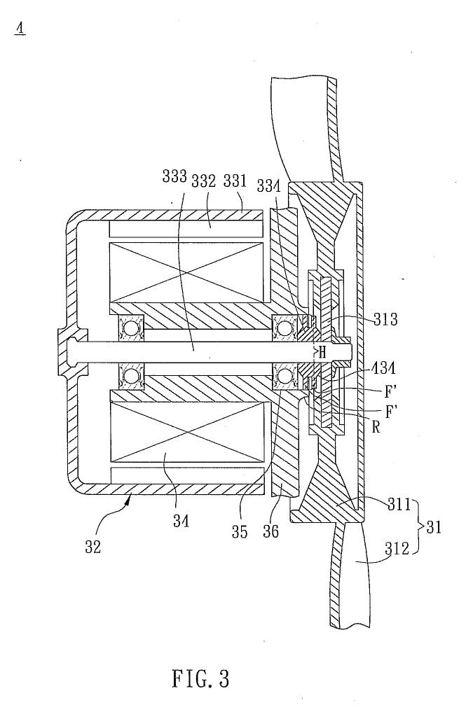

Referring to FIG. 3, the rotor 33 has a magnetic-conducting housing 331, a magnetic element 332 and a shaft 333. The magnetic element 332, such as a permanent magnet, is disposed on an inner wall of the magnetic-conducting housing 331. One end of the shaft 333 connected to the magnetic-conducting housing 331, and the other end connected to the hub 311 of the impeller 31. More specifically, the shaft 333 is connected to the hub 311 of the impeller 31 via a bracket 313.

The stator 34 has a stator magnetic pole, which is disposed corresponding to the magnetic element 332 of the rotor 33. The magnetic interaction between the magnetic element 332 and the stator magnetic pole can rotate the rotor 33, thereby rotating the impeller 31 to generate airflow.

The bearing 35 loops around the shaft 333 to make the shaft 333 operate smoothly. In this embodiment, the bearing 35 is a ball bearing, but just for example and not limited to. Of course, the bearing 35 can also be an oil bearing or a sleeve bearing.

The housing 36 includes a sleeve 361, which has an axial hole H and a projecting rib R formed on the periphery of the axial hole H. The shaft 333 passes through the axial hole H, and the bearing 35 is accommodated in the axial hole H. A spacer 334 loops the shaft 333 and urges against the bearing 35 and securely disposed in the axial hole H. In detail, the spacer 334 is disposed between the bearing 35 and the bracket 313, so that a predetermined distance exists between the motor 32 and the impeller 31.

As shown in FIG. 2, the spacer 334 further has at least one flange F which is mounted around the periphery of the spacer 334. The structure of the flange F enables the spacer 334 to be tightly secured to the axial hole H. One end of the spacer 334 urges against the bearing in order to position the bearing and thus to prevent the axial clearance from being generated. The flange F and the spacer 334 can be formed by way of powder metallurgy, lathing, molding or injection molding. The structure design of the spacer 334 can be modified according to the space and the dimension. Thus, the suitable distance and height can be controlled, the bearing 35 can be positioned accurately, and the foreign-body-proof and water-proof functions can be achieved.

As the results, the spacer not only can uses to the control of the distance and the height, but also to position the bearing urge against the bearing and to avoid the axial clearance of the bearing when the shaft is rotated at high speed. In addition, the foreign-body-proof and water-proof functions can also be provided.

FIG. 3 shows a fan 4 according to a second preferred embodiment of the present invention. The structure and the function of the fan 4 are similar to those of the fan 3 except that the fan 4 has a spacer 434, which has a plurality of flanges F′. The flanges F′ are disposed separately and in parallel, and further decrease the opportunity that the external water or moisture and the foreign bodies enter the fan. In this embodiment, two flanges F′ are disposed in parallel, but just for example and not limit to. Of course, more than two flanges F′ can be disposed around the spacer 434.

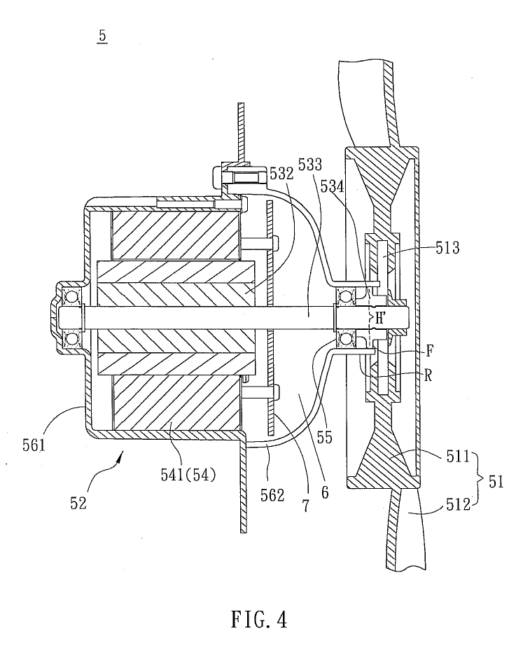

Referring to FIG. 4, a fan 5 according to a third preferred embodiment of the present invention which includes an impeller 51 and a motor 52. In this embodiment, the motor 52 is an inner rotor motor.

The impeller 51 includes a hub 511 and a plurality of blades 512, and the blades 512 are mounted around the periphery of the hub 511.

The motor 52 includes a rotor 53, a stator 54, at least one bearing 55 and a housing 56. The rotor 53 includes a magnetic element 532 and a shaft 533. The magnetic element 532 loop around the shaft 533. The stator 54 is disposed in the housing 56, and the magnetic element 532 of the rotor 53 is disposed corresponding to the stator. The bearing 55 loop around the shaft 533, the housing 56 has an axial hole H′ for accommodating the bearing 55 and the shaft 533. One end of the shaft 533 protrudes out of the housing 56 and is connected to the hub 511 of the impeller 51.

The housing 56 combine a first casing 561 with a second casing 562, which can assemble with each other by way of screwing, locking or engaging. In addition, an airtight space 6 for accommodating the stator 54, the rotor 53 and a driving device 7 is formed between the first casing 561 and the second casing 562. Therefore, it is possible to prevent the external foreign bodies and water or moisture from entering the motor. The material of the first casing 561 and the second casing 562 can be a plastic or metallic material.

In addition, the second casing 562 has the axial hole H′. A rib R is formed on the periphery of the axial hole H′, and support to securely couple for a spacer 534, and disposed between the bearing 55 and a bracket 513. The spacer 534 is securely couple to the axial hole H′ by the flange F disposed on its periphery so as to prevent the external foreign bodies and the water from entering the bearing or the motor via the lateral direction. Thus, the water-proof and dust-proof functions of the fan can be effectively enhanced.

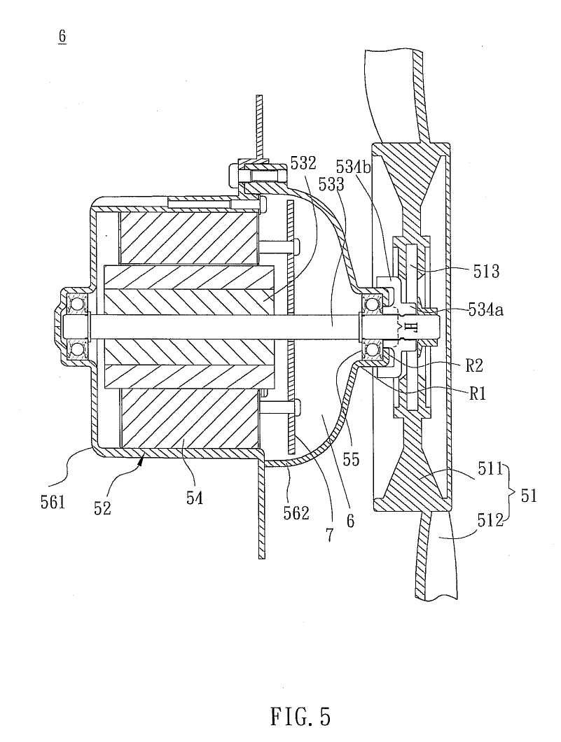

FIG. 5 shows a fan 6 according to a fourth preferred embodiment of the present invention, wherein the structure thereof is almost similar to that of the third preferred embodiment except that the rib R has not only an axial extension R1, but also a radial extension R2 extending toward the center of the shaft. A central portion 534a of the spacer is securely disposed in an axial hole H′ that defined by the radial extension R2, and a lateral portion 534b of the spacer is secured with the axial extension R1 of the rib to form two protecting effects. In addition, the spacer is formed by way of aluminum casting or plastic injection molding.

In summary, the fan and the motor according to the present invention have the spacer loops the shaft and disposed between the bearing and the bracket to close the axial hole of the housing by way of tightly securing. More specifically, the flange of the spacer is provided to shield the axial hole and by that to prevent the external moisture or water from entering the axial hole, cause damaging the member within the axial hole, such as the bearing. Compared with the prior art, the present invention can effectively prevent the water and the external foreign bodies from entering the motor, the distance and the height can be controlled, and the bearing can be positioned. Thus, the lifetime of the bearing can be lengthened, and the efficiency of the motor can be enhanced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A motor, comprising:
a rotor having a shaft;
a stator disposed corresponding to the rotor;
a housing for supporting the stator and the rotor and having an axial hole;
at least one bearing disposed in the axial hole for supporting the shaft; and
a spacer securely disposed in the axial hole, wherein the spacer loops the shaft and urges against the bearing.

2. The motor according to claim 1, wherein the spacer is formed by way of powder metallurgy, aluminum casting or plastic injection molding.

3. The motor according to claim 1, wherein the spacer has at least one flange mounted around a periphery of the spacer and shielding the axial hole.

4. The motor according to claim 2, wherein the spacer has a plurality of flanges, and the flanges are arranged separately and in parallel for shielding the axial hole.

5. The motor according to claim 2, wherein the flange and the spacer are formed by way of lathing, molding or injection molding, and an airtight space is formed between the first casing and the second casing, and for accommodating the stator and the rotor.

6. The motor according to claim 5, further comprising a driving device disposed in the airtight space.

7. The motor according to claim 1, wherein the housing comprises a first casing and a second casing, and the first casing is assembled with the second casing by way of screwing, locking or engaging.

8. The motor according to claim 7, wherein a material of each of the first casing and the second casing comprises a plastic material or a metallic material.

9. The motor according to claim 1, wherein the housing comprises a rib disposed on a periphery of the axial hole, and the rib has an axial extension and a radial extension extending toward a center of the shaft, a central portion of the spacer is securely dispose in the axial hole defined by the radial extension, and a lateral portion of the spacer is secured with the axial extension of the rib.

10. The motor according to claim 1, wherein the housing includes a sleeve having a rib disposed on a periphery of the axial hole, and the rib has an axial extension and a radial extension extending toward a center of the shaft, a central portion of the spacer is securely dispose in the axial hole defined by the radial extension, and a lateral portion of the spacer is secured with the axial extension of the rib.

11. A fan, comprising:
an impeller; and
a motor comprising:
a rotor having a shaft,
a stator disposed corresponding to the rotor,
a housing for supporting the stator and the rotor and having an axial hole, wherein the shaft passes through the axial hole, and one end of the shaft protrudes out of the housing and is connected to the impeller,
at least one bearing disposed in the axial hole for supporting the shaft, and
a spacer securely disposed in the axial hole, wherein the spacer loops the shaft and urges against the bearing.

12. The motor according to claim 11, wherein the spacer is formed by way of powder metallurgy, aluminum casting or plastic injection molding.

13. The motor according to claim 11, wherein the spacer has at least one flange mounted around a periphery of the spacer and shielding the axial hole.

14. The motor according to claim 13, wherein the spacer has a plurality of flanges, and the flanges are arranged separately and in parallel for shielding the axial hole.

15. The motor according to claim 13, wherein the flange and the spacer are formed by way of lathing, molding or injection molding.

16. The motor according to claim 11, wherein the housing comprises a first casing and a second casing, an airtight space is formed between the first casing and the second casing for accommodating the stator and the rotor, and a driving device disposed in the airtight space.

17. The motor according to claim 16, wherein the first casing is assembled with the second casing by way of screwing, locking or engaging, and a material of each of the first casing and the second casing comprises a plastic material or a metallic material.

18. The motor according to claim 11, wherein the housing comprises a rib disposed on a periphery of the axial hole, and the rib has an axial extension and a radial extension extending toward a center of the shaft, a central portion of the spacer is securely dispose in the axial hole defined by the radial extension, and a lateral portion of the spacer is secured with the axial extension of the rib.

19. The motor according to claim 11, wherein the housing includes a sleeve having a rib disposed on a periphery of the axial hole, and the rib has an axial extension and a radial extension extending toward a center of the shaft, a central portion of the spacer is securely dispose in the axial hole defined by the radial extension, and a lateral position of the spacer is secured with the axial extension of the rib.

20. The fan according to claim 11, wherein the motor is an inner rotor motor, an outer rotor motor or a vehicle motor.
